(19) United States
(12) Patent Application Publication
(10) Pub. No.: US 2007/0117487 A1
(43) Pub. Date: May 24, 2007

(54) High value laminated upholstery fabrics

(76) Inventors: Duncan Whitehead, Barrington, RI (US); Justin Silvia, Fall River, MA (US); David Pettey, Westport, MA (US); Xu Cal, Westport, MA (US)

Correspondence Address: GOTTLIEB RACKMAN & REISMAN PC, 270 MADISON AVENUE, 8TH FLOOR, NEW YORK, NY, 100160601, US

(21) Appl. No.: 11/079,896

(22) Filed: May 25, 2006

Related U.S. Application Data
(60) Provisional application No. 60/552,563, filed on Mar. 12, 2004.

(51) Int. Cl. D04H 3/16; B32B 5/26

(52) U.S. Cl. 442/268; 442/401

(57) ABSTRACT

A low-cost upholstery fabric formed by laminating a lightweight nonwoven to the back of a woven textile, as opposed to coating with a conventional latex system.

This application claims the priority date of U.S. Provisional No. 60/552,563 filed Mar. 12, 2004.

### FIELD OF THE INVENTION

This invention relates to low-cost woven fabrics for use as upholstery material. More particularly, this invention concerns woven fabrics that are laminated to lightweight spunbonded and carded thermally bonded nonwovens.

### BACKGROUND OF THE INVENTION

Manufacturing upholstery fabrics earmarked for the residential furniture market within the United States is a highly competitive endeavor. Furniture manufacturers have a continuing need for low cost furniture fabrics suitable for promotionally priced furniture. Effectively such fabrics compete in a low-margin, commodity market, to be contrasted with the middle and upper ends of the market, which have remained highly stylistic, and approaching mass-customization. At the low-margin portion of the market, there have been long term efforts to develop low cost fabrics that meet minimum performance criteria, margin expectations, while still having some market and aesthetic appeal.

This commodity environment faces severe competition from manufacturers outside the United States, who have the advantages of lower cost raw materials and labor, and the economies of scale of longer production runs of commodity products. Thus, residential upholstery fabrics are being increasingly imported into the United States. As a consequence, a highly competitive market for United States domestic manufactures is becoming a competitive impossibility.

To date, the limitation for achieving fabrics that meet the cost, physical, and aesthetic criteria has been achieved by a balance of yarn and latex backing weights. Latex backings are applied to fabrics to improve their strength (seam-slippage, tensile, tear, and the like). As latex systems tend to be 4 to 5 fold less expensive than woven yarn structures, heavy backings are widely used at this commodity portion of the market. However, there is a practical limit, where additional latex backing provides minimal added strength and certainly degrades aesthetics (fabrics become stiff and boardy). Additionally, as fabric weight goes down, it becomes more difficult to add heavier backings, without the latex system bleeding (penetrating) to the face of the fabric. Finally, while additional latex backing may improve some physical properties, it is at the expense of other properties (for example seam-strength vs. elongation). What's more, with the majority of fabrics being softened today, the higher add-on levels require more aggressive (more costly) softening processes, further eroding the cost benefits of adding more latex backing.

U.S. Pat. No. 4,122,227 disclosed a laminated knit fabric for use as upholstery material consisting of knitted upholstery yarns adhered to a flexible, non-extensible back fabric. A knitted fabric was required in order to provide rich and heavy type designs and the backing was required to overcome the property of knitted fabrics to stretch. Latex backing was avoided because it did not sufficiently limit stretching. The '227 patent discourages the use of its invention with woven fabrics. It states “Being woven, the upholstery fabric is intrinsically stable, thus there has been no need to provide further stabilization.” (Col. 2, lines 60-62) The '227 patent further suggests that the most suitable backing be a lightweight woven textile fabric. (Col. 5, lines 54-57) Alternatively it suggests a fusible lightweight woven or nonwoven textile material for the backing (Col. 6, lines 9-13) and eliminating a separate layer of adhesive material. The only example in the '227 patent uses a cotton woven backing.

### BRIEF DESCRIPTION OF THE INVENTION

The seemingly insurmountable hurdle of cost reduction can in fact be overtaken via the creative use of technology. Minimizing the reliance on the more labor intensive spinning and weaving operations, and taking fuller advantage of lower-labor high-technology finishing operations is the key. Stated differently, fabrics offered to this market must utilize fewer components from the more expensive yarn and weaving processes. For example, if a 7.0 ounce fabric could be manufactured to be aesthetically and physically equivalent to a 10.0 ounce fabric, then that fabric could be offered to the market at (all else being equal) a 30% improved cost/price.

Thus the aforementioned limitations of the prior art can be overcome by laminating a lightweight nonwoven to the back of the fabric, as opposed to coating with a conventional latex system.

### BRIEF DESCRIPTION OF THE DRAWINGS

FIG. 1 is a plan view of a product of the invention.

FIG. 2 is a cross section of a product of the invention having an adhesive layer.

FIG. 3 is a cross section of a product of the invention without a separate adhesive layer.

### DETAILED DESCRIPTION OF PREFERRED EMBODIMENTS

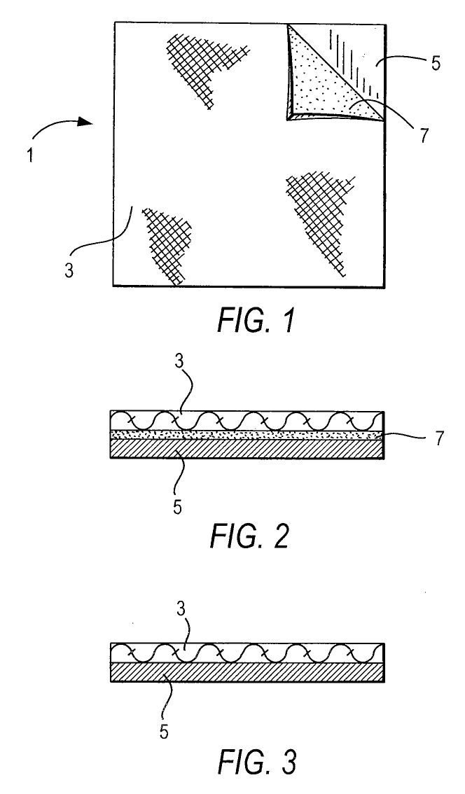

As shown in FIG. 1, A lightweight nonwoven 5 is laminated to the back of a woven fabric 3, to produce a laminate 1, as opposed to coating the fabric with a conventional latex system. The nonwoven 5, must be selected that yields the required added physical properties, as well as such aesthetic considerations as: fabric drape, softness, and body. Lightweight spunbonded and carded thermally bonded nonwovens are well suited for this purpose. Preferred are nonwoven webs made of Olefin or Polyester, having a weight range of 0.5 to 2.0 ounces per linear yard. Spunbonded Olefin nonwoven have been found to be the ideal, as they offer excellent CD:MD strength and uniformity, as well as have high bulk per weight properties. (Tensile strength is often measured in MD and CD. MD is “machine direction” meaning lengthwise. CD is “cross direction” and is the width of the fabric.)

The selected nonwoven web can be attached via any of the conventional means, with hot melt adhesives being the preferred (low cost) process. Examples of hot melt coating technologies applicable for this process include: sinter, slot die, gravure, and reverse roll. FIG. 2 depicts the layers of the laminate where 7 is a layer of adhesive adhering the woven fabric 3 to the lightweight nonwoven material 5.

When optimally attached to the textile, the laminated nonwoven web dramatically increases the strength of the total textile system (in the order of 50% compared to conventionally backed products—same weave and yarn constructions, differing only the backing systems). This added strength therefore enables the textile product to be produced with fewer, of the more costly raw materials (warp and filling yarns). Thus fewer warp and filling yarns/inch are required, and or, warp and filing yarns of lower linear density. Examples of appropriate woven materials are the following:

Once attached, the combined nonwoven and textile is softer (has more drape) than a conventionally backed product. Therefore, when it enters into softening equipment, effectively in a pre-softened condition, it requires less softening energy. These fabrics are therefore able to be processed at high processing speeds, which translates to lower/yard costs.

Owing to the nonwoven's bulk properties, once laminated despite their being less yarn weight in the textile, the total structure is of higher bulk and body. Higher, with respect to an equivalent weight product conventionally backed with latex. The final product although lighter, provides the consumer with more body and bulk, all the while exhibiting improved physical properties.

The adhesives used to attach the nonwoven are typically translucent, and the nonwoven itself is further away from the face of the fabric, again compared to conventional latex backings. These two characteristics enable strength to be imparted to the textile, without having the aforementioned problems of latex bleed through.

Additionally, should an “open” (gauze-like) textile be developed, where one can see through the fabric, nonwovens can also provide a unique technical solution.

Spunbonded fabrics are available in a variety of colors, which provide the ability to match the nonwoven to the textile. This ability to match backings (nonwoven) with the textile, provides the designer with enhanced flexibility to explore further constructions that are cost advantageous. The process for the manufacture of a product of the present invention involves the following steps. The low cost woven fabric may be produced at 1/150 warp yarns and <10 picks per inch. This is contrasted with standard weaving of 1/270 warp yarns and >12 picks per inch. The weaving proceeds on the same needle loom as used for standard weaving. A backcoating of 1.25 oz/ly of a nonwoven fabric and 0.75 oz/ly of adhesive is applied at 266° F. and 30 YPM. This contrasts with the standard 2 oz acrylic latex backing at 270° F. and 35 YPM. A final softening step is accomplished at >35 YPM and 240° F., contrasted with only 25 YPM for a standard softening process. It should be understood that where precise values are stated, approximately those values are implied where the approximation is on the order of plus or minus 10 percent.

Although particular embodiments of the invention have been described, it will be apparent to persons of ordinary skill in the relevant arts that the invention may be practiced by modifications that do not depart from the substance of the invention. Accordingly the scope of protection of this patent should not be limited to the disclosed embodiments but should be determined from the following description of the invention in terms of claims.

1. A composite upholstery material comprising a woven fabric laminated to a non-woven material.

2. The composite material of claim 1, wherein the nonwoven fabric material comprises a lightweight spunbonded fabric.

3. The composite material of claim 1, wherein the nonwoven fabric material comprises a carded thermally bonded material.

4. The composite upholstery material of claim 1, wherein the nonwoven fabric is made of Olefin or Polyester.

5. The composite upholstery material of claim 1, wherein the nonwoven fabric has a weight of approximately 0.5 to 2.0 ounces per linear yard.

6. The composite upholstery material of claim 4, wherein the nonwoven fabric has a weight of approximately 0.5 to 2.0 ounces per linear yard.

7. The composite upholstery material of claim 4, wherein the nonwoven fabric is spun bonded Olefin.

8. The composite upholstery material of claim 4, wherein the woven fabric is notopaque and the nonwoven fabric is spunbonded Olefin color matched to the woven fabric.

9. The composite upholstery material of claim 5, wherein the nonwoven fabric is spun bonded Olefin.

10. The composite upholstery material of claim 5, wherein the woven fabric is not opaque and the nonwoven fabric is spunbonded Olefin color matched to the woven fabric.

11. The composite upholstery material of claim 1, wherein a hot melt adhesives adheres the woven fabric to the nonwoven material.

12. The method for producing a composite upholstery material comprising a woven fabric laminated to a non-woven material, comprising
producing a woven fabric at approximately 1/150 warp yarns and approximately <10 picks per inch, on a needle loom,
applying a backcoating of approximately 1.25 oz/ly of a nonwoven fabric with approximately 0.75 oz/ly of adhesive is applied at approximately 30 YPM,
softening the woven fabric with its backcoating at greater than approximately 35 YPM.

13. The method for producing a composite upholstery material of claim 12, wherein the step of applying a backcoating with adhesive applies a hot melt adhesive by sinter,slot die, gravure, or reverse roll method
